(19) United States
(12) Patent Application Publication
(10) Pub. No.: US 2013/0109469 A1
(43) Pub. Date: May 2, 2013

(54) Method and Apparatus for Revectoring Game Displays

(71) Applicant: Rodney E. Hill, Cumming, GA (US)

(72) Inventor: Rodney E. Hill, Cumming, GA (US)

(73) Assignee: SCIENTIFIC GAMES INTERNATIONAL, INC., Newark, DE (US)

(21) Appl. No.: 13/282,941

(22) Filed: Oct. 27, 2011

(51) Int. Cl. A63F 13/00

(52) U.S. Cl. 463/31

(57) ABSTRACT

The present disclosure relates to methods and apparatus for providing an enhanced game play experience via enabling a player to engage in game play on a primary portion of a display while simultaneously receiving separate, unassociated media displayed on at least one secondary portion of the display.

### FIELD OF THE INVENTION

The present disclosure relates in general to methods and apparatus for providing an enhanced game play experience via enabling a player to engage in game play on a primary portion of a display while simultaneously receiving separate, unassociated media displayed on at least one secondary portion of the display. The proposed methodologies and apparatus allow for an enhanced game play experience by allowing players to simultaneously engage in game play while also experiencing other media feeds.

### BACKGROUND

Gaming machines, such as game terminals, are a fundamental type of gaming entertainment provided at gaming establishments and other locations. Gaming machines provide nearly countless gaming possibilities for players and typically include high resolution displays as well as advanced audio feeds in order to further heighten the gaming experience.

In North America alone there are over 880 gaming facilities with over 880,000 gaming machines. Gaming establishments continually strive to keep the gaming machines interesting and attractive to players via the introduction of new games and new technologies in order to enhance and extend the game play process. The goal being to provide the player with a gaming machine that not only maintains the player's attention but also entices the player to continue gaming.

For example, existing gaming machines can provide video output to two portions of a video display. The first portion of the video display delivers game content such as poker, keno, blackjack games, etc. The second portion of the display provides basic game information such as paytable information, award levels, game animation, and bonuses or awards achieved through game play. These existing gaming machines typically contain a game operating system that manages hardware and communicates to peripheral devices such as bill acceptors, touchscreens, buttons, etc. These gaming machines also contain a library of games with associated paytables, graphics, audio and rules for each game.

What is needed are improved methods and apparatus for providing game play as well as for enhancing the game play experience. This may be accomplished by not only delivering game play and associated game play information but also simultaneously delivering other unassociated media content to the player, without adversely impacting game play. This could encourage the player to remain at the gaming machine for further game play. It also encourages and maintains player interaction with existing gaming machines through the introduction of new and interesting types of media on the existing game devices thereby extending the useful life of existing game devices and reducing expenses incurred in replacing or “upgrading” these devices.

### SUMMARY

Aspects and advantages of the invention will be set forth in part in the following description, or may be obvious from the description, or may be learned through practice of the invention.

Described are a number of methodologies and apparatus that provide simultaneous game play and media experiences for players at gaming machines.

In one exemplary embodiment, the prevent disclosure includes a method for providing media on a gaming terminal. The method includes a controller capturing at least one media feed originating from a gaming terminal. The controller reformats the media feed to occupy a first portion of a display and transmits the reformatted media feed and a user interface to the display wherein the user interface occupies a second portion of the display. A second media is provided via the user interface and is unassociated with the content of the media feed.

In variations of this particular embodiment, the media feed originating from the gaming terminal comprises a video feed. In a further embodiment, the media feed originating from the gaming terminal comprises at least one audio and at least one video feed.

In other embodiments, reformatting the media feed to occupy a first portion of the display is achieved by reducing the size of a video portion of the media feed on the display. In still further embodiments, the size of the video portion can be reduced by at least 25%. In other embodiments, the reformatting occurs by using a software algorithm to reformat the media feed.

In other embodiments, the first portion of the display occupies a larger area of the display than the second portion of the display. In still other embodiments, the second media may exchange positions on the display with the reformatted media feed. In further embodiments, the second media may occupy the entirety of the display. In still further embodiments, the user interface allows the user to supplant the reformatted media feed with media provided by the controller.

In still other embodiments, the user interface provides at least two forms of media in the second portion of the display. In further variations of this embodiment, the second media may be selected from streaming video, live sports feeds, pay-per-view selections, Internet websites, news feeds, weather forecasts, gaming establishment advertisements, wagering events, game play, or real-time video.

In yet further embodiments, the second media comprises interactive media such that the user may influence the second media. In still further variations of this embodiment, the interactive media comprises at least wagering, gaming, social or communications media. In a yet still further embodiment, the user interface provides similar gaming activities that are unassociated with the gaming activities supplied via the gaming terminal. In a still further variation on this embodiment, the user interface provides similar gaming activities as the gaming terminal but game play and results of the games are not intertwined nor dependent upon one another.

Another embodiment of the present disclosure is directed to an apparatus for providing media on a display. The apparatus includes a media player for intercepting at least one feed originating from a device. The media player reformats the at least one feed to occupy a first area of a display wherein the area occupied is less than the area the at least one feed would have occupied before reformatting. The media player transmits the reformatted at least one feed and a user interface to the display, the user interface occupies a second area of the display. The user interface is configured to provide media unassociated with the at least one feed originating from the device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

FIG. 1 is a front plan view of a prior art gaming machine display showing game play coupled with a description of game play options.

FIG. 2 is a schematic view of one embodiment of the disclosure wherein media transmitted from a gaming terminal is intercepted by a controller.

FIG. 3 shows a front plan view of one embodiment illustrating a resulting display with reformatted media occupying a first portion of the display and a user interface and second media occupying a second portion of the display.

FIG. 4 shows a schematic view of one embodiment of the disclosure where media is reformatted via a controller using an algorithm to produce reformatted media.

FIG. 5 illustrates an embodiment where second media supplants the location of reformatted media on the display.

FIG. 6 shows an embodiment wherein second media first occupies a second portion of the display and then occupies the entirety of the display while temporarily or permanently displacing the reformatted media.

FIG. 7 shows an embodiment wherein the user interface provides multiple types of second media in the second portion of the display.

FIG. 8 illustrates a decision flow chart of one embodiment of the disclosure where the user may select additional media for display instead of the reformatted media.

FIG. 9 illustrates a display after the user has activated a media delivery icon and selected additional media from an additional media delivery system, thus transplanting the reformatted media with the additional media.

FIG. 10 shows one possible embodiment of the disclosure as it may appear to the user after activating the additional media selection in order to view the additional media options.

FIG. 11 shows one possible embodiment of a media player as described with respect to the disclosure.

FIG. 12 is a block diagram of one embodiment of the media player showing creation of a user interface as well as input into and output from the user interface.

FIG. 13 illustrates a schematic view of one possible embodiment of a hard drive in a media player partitioned into particular regions and the interactions between same.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

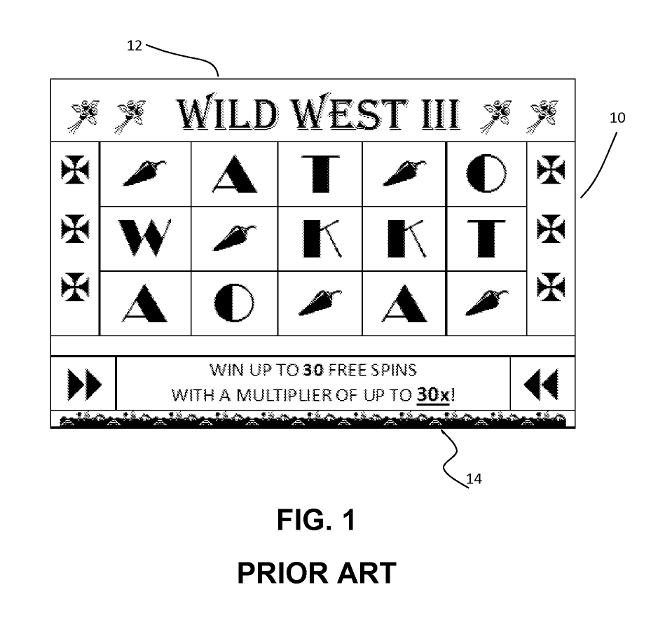

FIG. 1 illustrates a prior art display 12 showing the game display 10 occupying display 12 along with game related communication 14. As FIG. 1 illustrates, the game play area of the display 12 is almost completely dominated by the game. Game related information 14 is also provided but occupies a small portion of the display 12 and simply provides information about the game being played.

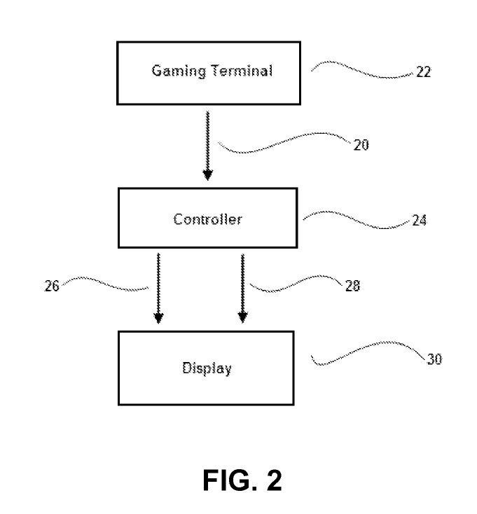

FIG. 2 illustrates a schematic view of one embodiment of the disclosure wherein media 20 is transmitted from gaming terminal 22 and intercepted by controller 24. Gaming terminal 22 may be any type of gaming terminal 22, or other media device, such a home theatre, hotel interactive menu, video game, etc., which provides at least one video feed, preferably at least one audio feed and at least one video feed, directed to and displayed on a screen or other viewing or acoustic device. Controller 24 also transmits user interface 28 to display 30.

With respect to FIG. 2, interception of media 20 can occur by media 20 being physically directed to controller 24. For purposes of example only and not intended to be limiting, the audio, visual, or other feeds that comprise media 20 can be transmitted to controller 24 by audio and/or video inputs in the form of cables or other physical linkages. Preferably media 20 comprises at least one video feed and more preferably at least one audio feed and at least one video feed but higher numbers of each feed are contemplated herein.

The audio feed can comprise, for purposes of example only and not intended to be limiting, a compressed audio stream using an audio codec such as MP3, Vorbis or ACC. The video feed can comprise, for purposes of example only and not intended to be limiting, a compressed video stream using a video codec such as H.264 or V8. In one embodiment, the encoded audio and/or video streams are assembled in a bitstream, a contiguous sequence of bits, representing a stream of data, transmitted continuously over a communications path, serially (one at a time), such as FLV, WebM, ASF or ISMA. In another embodiment, the bitstream can be delivered from gaming terminal 22 to controller 24 using a transport protocol such as MMS or RTP, both of which can also function as control protocols. Wireless interception of media 20 could also occur with controller 24 intercepting the wireless communication comprising media 20 via a receiver (not shown) as known to those skilled in the art.

Referring again to FIG. 2, media 20, once intercepted, is then transformed by the controller into reformatted media 26. In one embodiment, the transformation of media 20 may occur through the use of an algorithm. In a further embodiment, the algorithm may be used to reduce the size of the video feed shown on display 30. For instance, the video feed can be compressed to about 90%, 75%, 50%, 25%, 10%, or 5% of its original size, as well as ranges of these values such as from about 90% to about 75%, from about 75% to about 50%, from about 50% to about 25%, or from 25% to about 10% of its original size. This size reduction may be accomplished in one embodiment by, for purposes of example only and not intended to be limiting, the use of various video coding techniques. For example, in one embodiment, H.264/MPEG-4 AVC coding, a commonly used format for recording that is a block-oriented motion-compensation-based codec standard developed by the ITU-T Video Coding Experts Group (VCEG) together with the ISO/IEC Moving Picture Experts Group (MPEG), may be used. Alternatively, Hypertext Markup Language (HTML) can also be used for this purpose. HTML is a language for structuring and presenting content on the World Wide Web.

With respect to MPEG coding, compression and distribution of high definition video can occur in conjunction with bit-plane DCT encoding techniques, which involves dividing a video frame into 8×8 parts, then scanning the 64 coefficients by the use of Zig-Zag scanning patterns, as known to those skilled in the art, wherein the 64 coefficients are encoded in order from high to low. Utilities such as DGIndex may also be useful in reducing the size of an image on a display including decoding and indexing most MPEG streams including elementary streams, program streams, VOBs, VCDs, SVCDs, PVA files, and transport streams.

In an alternative embodiment, video scalers may be combined with video processing devices or algorithms, as known to those skilled in the art, to vary the size of reformatted media 26. Video scalers are devices for converting video signals from one size resolution to another and can also be used for upconverting low resolution signals to high resolution signals in order to not degrade the quality of reformatted media 26. This may be useful in one embodiment where the method of providing reformatted media 26 actually enhances the quality of media 20 provided by gaming terminal 22 in addition to supplying second media 36. The aspect ratio of media 20 could also be manipulated to size reformatted media 36 to a display or the aspect ratio may be maintained consistent with the aspect ratio of media 20. The following formulae can be used to find the height (h), width (I for length) and area (A) of an image, where r stands for ratio and d for diagonal length.

$$h = \frac{d}{\sqrt{{r}^{2} + 1}}$$

$$l = \frac{d}{\sqrt{\frac{1}{{r}^{2}} + 1}}$$

$$A = \frac{{d}^{2}}{r + \frac{1}{r}}$$

The aspect ratio of an image as displayed is commonly referred to as the Display Aspect Ratio (DAR), which can be manipulated from the Original Aspect Ratio (OAR) of the media 20.

In another embodiment, alpha blending may be used to display second media 36. Alpha blending involves combining a translucent foreground color with a background color, thereby producing a new blended color. The degree of the foreground color's translucency may range from completely transparent to completely opaque. If the foreground color is completely transparent, the blended color will be the background color. Conversely, if it is completely opaque, the blended color will be the foreground color. Of course, the translucency can range between these extremes, in which case the blended color is computed as a weighted average of the foreground and background colors. Through alpha blending, second media 36 could be rendered translucent and overlay reformatted media 26. In still other embodiments, reformatted media 26 could be rendered translucent to overlay second media 36.

In a further embodiment, image scaling can be used to resize an image. As known to those skilled in the art, resizing an image to increase its size results in the pixels, the smallest visual element on a video display screen (e.g., a computer terminal or television), comprising the image becoming more visible as the size of the image increases. Thereby making the pixels more visible to the viewer and making the image appear “soft.” Enlarging an image is generally used to make smaller imagery fit a bigger screen in full screen mode. In “zooming” an image, it is not possible to discover any more information in the image than already exists, and image quality inevitably suffers.

Conversely, reducing an image will tend to enhance its smoothness and apparent sharpness. Thus, by resizing media 20 into reformatted media 26, the image the user experiences may become more crisp and pleasing, thus heightening game play and providing an improved game experience. Various imaging scaling possibilities exist. For purposes of example only and not intended to be limiting, the following are examples of scaling possibilities, nearest-neighbor interpolation, bilinear interpolation, bicubic interpolation, hqx, pixel art scaling algorithms, and supersampling.

In a further embodiment, pixel art scaling algorithms may be used to resize the image. Various algorithms exist and may be used in the current disclosure for scaling purposes. For purposes of example only and not intended as a limitation, suitable algorithms include EPX/Scale2x/AdvMAME2. An example of the algorithm is provided below:

```
A  --\ 1 2
C P B [symbol]    / 3 4
  D
  1=P; 2=P; 3=P; 4=P;
  IF C==A AND C!=D AND A!=B => 1=A
  IF A==B AND A!=C AND B!=D => 2=B
  IF B==D AND B!=A AND D!=C => 4=D
  IF D==C AND D!=B AND C!=A => 3=C
```

Other suitable algorithms include Scale3x/AdvMAME3, Eagle, 2xSal, Super 2xSal, Super Eagle, hqnx family, and RotSprite.

In a further embodiment, image editors may be used to resize media 20 into reformatted media 26. Image editors use a mathematical process called resampling to calculate new pixel values whose spacing is larger or smaller than the original pixel values. Image editors may create an image histogram of the image being edited. The histogram plots the number of pixels in the image (vertical axis) with a particular brightness value (horizontal axis). Algorithms in the image editor allow the user to visually adjust the brightness value of each pixel and to dynamically display the results as adjustments are made. Improvements in picture brightness and contrast can thus be obtained. Image editors can also alter an image by rotating it in any direction and to any degree. Various image editors are available and known to those skilled in the art. For purposes of example only and not intended to be limiting, examples of image editors include IMAGE PHOTO, available from Imagicphoto.com, TOPAZ, available from Topaz Labs in Dallas, Tex., and PHOTOSHOP, available from Adobe, Adobe Systems Incorporated, 345 Park Avenue, San Jose, Calif. 95110-2704.

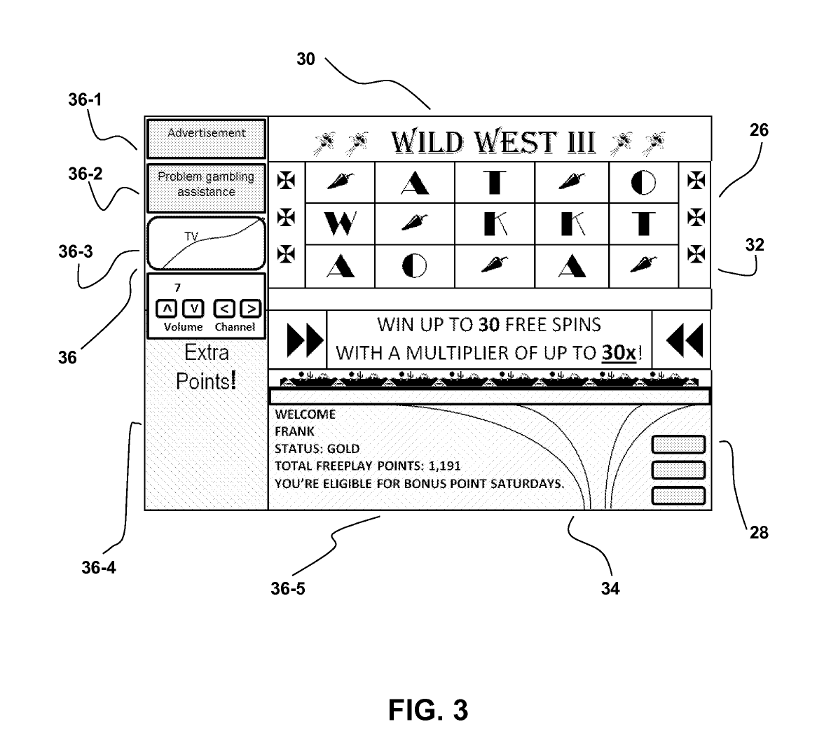

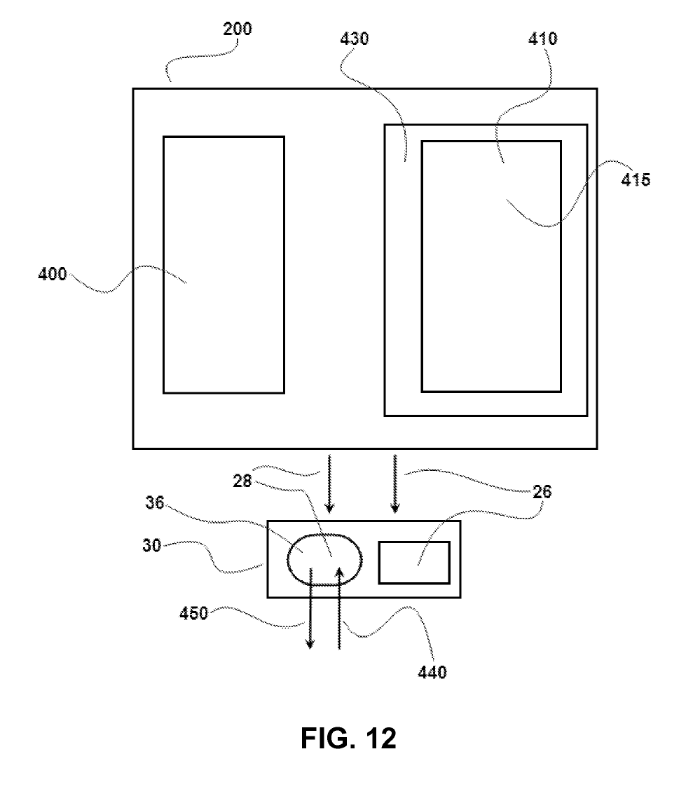

FIG. 3 illustrates one embodiment of display 30 showing reformatted media 26 occupying a first portion 32 of display 30 and user interface 28 occupying a second portion 34 of display 30. As described below in more detail, and as illustrated in FIG. 12, user interface 28 allows for input 440 from the user as well as output 450 from the user interface 28. This allows the user to interact with user interface 28 in order to, among other things, manipulate and/or select second media 36.

Referring again to FIG. 3, second media 36 may comprise streaming media such as media streamed, for purposes of example only, by the Real-time Streaming Protocol (RTSP), Real-time Transport Protocol (RTP) and the Real-time Transport Control Protocol (RTCP). The media may include any matter suitable for streaming including sports broadcasts, advertisements, podcasts, news events, movies, pay-per-view programs, on-demand features, closed circuit television feeds, digital television feeds, music streaming, webcasts, web syndication, web television, live television feeds, and data feeds.

Second media 36 may also comprise any and all applicable gaming content such as, for purposes of example only and not intended to be limiting, games of chance, games of skill, video slots, ball games such as Keno or bingo, video poker, parimutuel events, sports betting, fixed odds betting, arbitrage betting, and video lottery games.

User interface 28, in one embodiment, is configured to allow player input 440 with second media 36 in order to allow a player to place wagers on applicable gaming content while also experienced reformatted media 26 on gaming terminal 22. In a further embodiment, when second media 36 comprises gaming content, the gaming content may be completely unassociated with gaming content provided via reformatted media 26 and in no way dependent upon the results of same. However, in further embodiments, joint interaction between the second media 36 and reformatted media 26 may be allowed such as bonus arrangements whereby prizes obtained in either format enhance or increase prizes awarded in the other format but do not influence game play of either reformatted media 26 or second media 36. For purposes of example only, a win in reformatted media 26 may provide a bonus possibility for game play provided by second media 36, even though the games may be inherently unrelated to one another, have different rules, or involve different playing, wagering or skill abilities. Such an embodiment builds player excitement as well as gives the impression of increased rewards and additional game play. “Punitive” examples are also possible in other embodiments where poor results or poor game play result in loss of bonus possibilities in the other media.

As FIG. 3 illustrates, in one embodiment second media 36 occupies second portion 34. While FIG. 3 shows second media 36 arranged to the left and below reformatted media 26, this disclosure is not so limited and any physical placement of second media 36 with respect to reformatted media 26 is contemplated. In further embodiments, second media 36 may completely surround reformatted media 26, be placed in a side-by-side relationship, share a picture within picture placement, or any such appearance as known to one of skill in the art. It is also understood that second media 36 is intended to be displayed simultaneously with reformatted media 26 such that game play associated with reformatted media 26 is not impacted by the placement of second media 36. However, in other embodiments, it is contemplated that second media 36 may supplant reformatted media 26 temporarily or permanently during the game session until the player ceases play at gaming terminal 22. Upon cessation of game play, gaming terminal 22 will revert to the display showing reformatted media 26 and second media 36. In still other embodiments, player registration and login may be required to gain access to second media 36.

As FIG. 3 further illustrates, in one embodiment, second media 36 includes gaming or casino advertisements 36-1, help information such as contact information for problem gambling assistance 36-2, a television feed 36-3 wherein the user may control the channel being displayed as well as the volume of the program through user input 440, player reward card specials 36-4, as well as player status information 36-5. All of second media 36-1 through 36-5 may be unrelated to the reformatted media 36 and not intertwined with same or dependent on game play or game play results obtained by playing a game on reformatted media 26. In further embodiments, second media 36 may include concierge information for communicating with venue staff.

As FIG. 3 illustrates, second media 36 remains present on the screen. However, second media 36 may be reorganized within second portion 34 based on player input 440 such as allowing the user to control the number of second media 36 presented, the arrangement of second media 36 on the screen, as well as in some embodiments allowing the user to maximize portions of second media 36 to partially or completely displace space occupied by reformatted media 26.

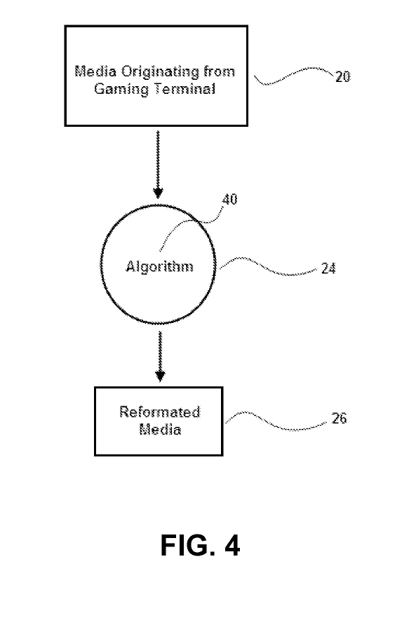

FIG. 4 illustrates one embodiment of the disclosure where media 20 is reformatted via controller 24 using algorithm 40 to produce reformatted media 26. As discussed above, various algorithms, devices and protocols are available to promote reformatting media 20 into reformatted media 26, which is then delivered to display 30. Media 20 may be reformatted by changing its size or appearance, adding content, removing content, enhancing the display, aspect ratio, or appearance of media 20, altering the appearance of media 20 to better cooperate with the “theme” of second media 36 by changing the color, appearance, font or other characteristics of media 20 to more closely match those in second media 36, and allowing the user to control the appearance of reformatted media 26 through input 440.

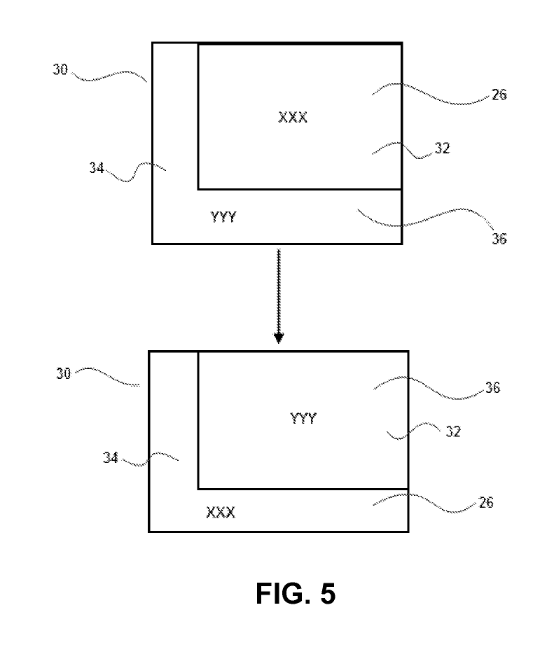

FIG. 5 illustrates a further embodiment where second media 36 may supplant the location of reformatted media 26 on display 30. As FIG. 5 illustrates, second media 36 may switch from the second portion 34 to occupy the first portion 32 of the display 30. This may be accomplished, in one embodiment, by the use of programming software present in controller 24. One example of suitable software, for purposes of example only, includes HTML coding.

In a further embodiment, image switching, overlaying or alpha blending may be accomplished using a device such as a multiplexer. A multiplexer is a device that selects one of several input signals and forwards the selected input to the output, here display 30. A demultiplexer may also be used. This device takes a single input signal that carries many different feeds and separates those over multiple output signals, for example the various forms of second media 36 provided on display 30. In further embodiments, a multiplexer can be combined with a demultiplexer on the receiving end of the input. For purposes of example only and not intended to be limiting, an MPX-CD92P or MPX-MS92P multiplexer, both available from Sanyo Fisher Company, 21605 Plummer Street Chatsworth, Calif. 91311, could be used. In a further example, a multiplexer may also be used to provide the various forms of second media 36 placed in conjunction with reformatted media 26. In a still further embodiment, controller 24 may provide separate feeds comprising second media 36 to display 30 with the position, size, appearance, user interface ability, and format of each determined by controller 24.

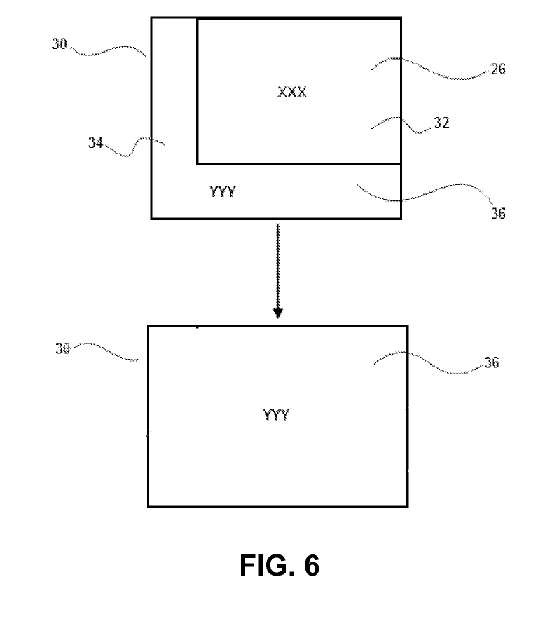

FIG. 6 shows an embodiment wherein second media 36 may at first occupy second portion 34 (or first portion 32, not shown) and then occupy the entirety of display 30 while temporarily or permanently displacing reformatted media 26. The displacement of reformatted media 26 may be accomplished via various means. In some embodiments, controller 24 may simply cease transmitting reformatted media 26 and then direct second media 36 to occupy the entirety of display 30. In other embodiments, a multiplexer or appropriate software coding may be used to replace reformatted media 26 with second media 36 as described herein. The displacement may be controlled by controller 24 and can be permanent or for a limited time. For example, in one embodiment, an urgent announcement such as a win on a game being played in second media 36 may result in displacing reformatted media 26 in order to bring the player's attention to the winning condition. In other embodiments, displacement of reformatted media 26 may be used by controller 24, or the venue, to communicate with the player via second media 36. Further, in other embodiments, the player may set specific parameters, such as a starting time for streamed television programming to result in displacing reformatted media 26 in order to inform the user that the program is beginning.

In still other embodiments, second media 36 may usurp display 30 when a player has wagered and lost a preset amount as predetermined by the user, the venue, or controller 24. When the preset limit is reached, game play may cease and second media 36 may usurp the display to inform the player that further game play is suspended for the moment.

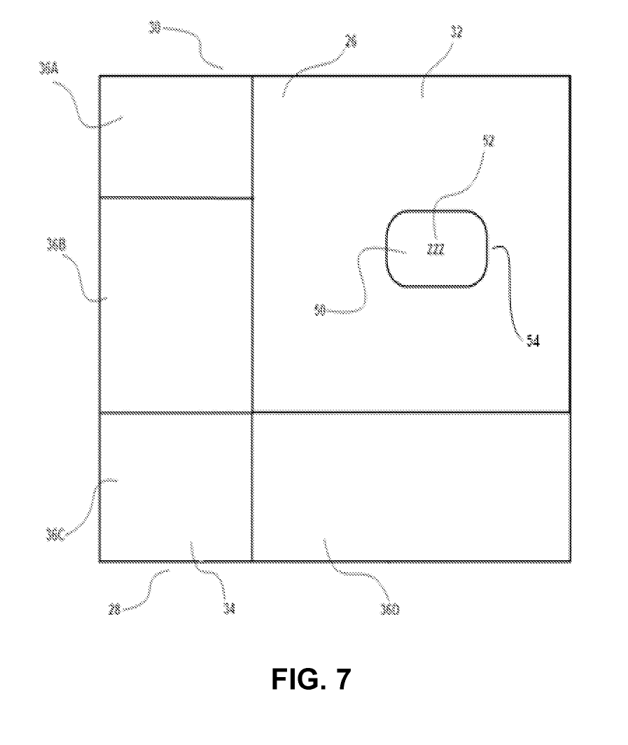

FIG. 7 shows an embodiment wherein the user interface 28 provides multiple types of second media 36 illustrated by 36A, 36B, 36C and 36D in the second portion 34 of display 30. The number of media provided by interface 28 is not limiting and may be more or less than the four shown and is constrained only by the capabilities of the display serving as a medium for experiencing the media in view of the associated devices such as a multiplexer and/or the software programming in controller 24. Media 36A-D may be the same or different and can comprise second media 36 as described herein.

Referring again to FIG. 7, in an additional embodiment, the user is provided the opportunity to exchange the reformatted media 26 for additional media 52 provided by controller 24 by selecting or otherwise activating media delivery icon 50 to activate additional media delivery system 54. While FIG. 7 shows media delivery icon 50 located in first portion 32 along with the reformatted media 26, the position of icon 50 may be in either the first portion 32 or second portion 34 of the display 30 or may be superimposed over both first portion 32 as well as second position 34 or may “float” over the display 30 without being affixed to a particular location on the display 30.

Selection or activation of media delivery icon 50 causes controller 24 to provide access to additional media delivery system 54. Additional media 52 allows for further enhancing game play by providing gaming experiences and options separate from and in addition to those supplied through reformatted media 26. Further, in one embodiment, additional media 52 is provided by a host that is independent of the venue providing media 20 for gaming terminal 22. Thus, in one embodiment, in the event of a catastrophic failure with respect to providing media 20, additional media 52 may still be provided in order to allow for game play and keep users enticed and present at game terminal 22. In a yet further embodiment, additional media 52 could also be interactive as described herein with respect to user interface 28.

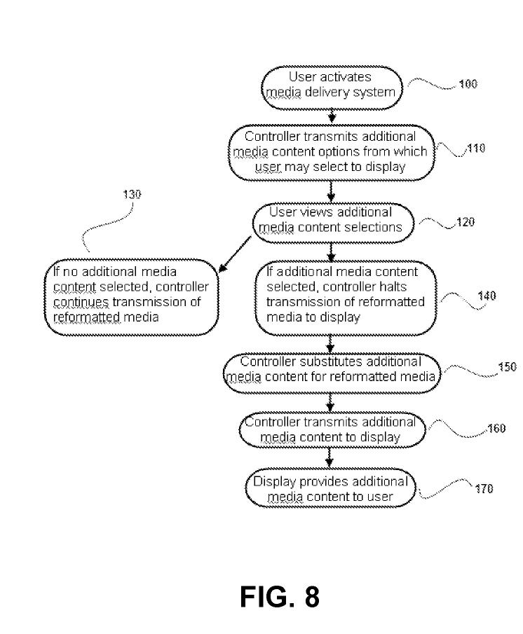

FIG. 8 illustrates an embodiment of the disclosure where the user may select additional media 52 for display instead of reformatted media 26 transmitted from a gaming terminal or other device. In step 100 the user activates additional media delivery system 54. As shown in FIG. 7, additional media 52 may be accessed through additional media delivery system 54. In one embodiment, additional media delivery system 54 is represented by a delivery icon 50 appearing on display 30. A user can select or activate delivery icon 50 via various methods known to those skilled as well as those described herein with respect to user interface 28. Once the user activates additional media delivery system 54, controller 24 at step 110 causes the display 30 to provide a listing, directory, visual display, or other form of content that explains the various types of additional media 52 available to the user. The user views the additional media 52 selections on the display 30 at step 120. If the user does not select additional media 52, step 130, the controller 24 continues to transmit reformatted media 26 as described above. However, if the player selects additional media 52, step 140, controller 24 ceases to transmit reformatted media 26 to display 30. Then, at step 150, controller 24 substitutes additional media 52 for reformatted media 26 and transmits this to display 30 at step 160. Display 30 then provides additional media 52 to the user at step 170.

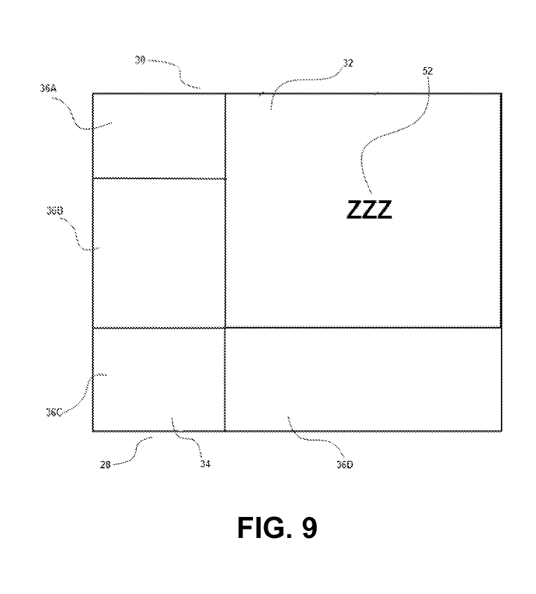

FIG. 9 illustrates display 30 after the user has activated media delivery icon 50 and selected additional media 52 from additional media delivery system 54, thus transplanting reformatted media 26 with additional media 52. Additional media 52 may be the same or different as the media 36A-D operating in second portion 36 of display 30. In a further embodiment, additional media 52 may exchange locations with any of second media 36 via user input 440 reorganizing the appearance of display 30.

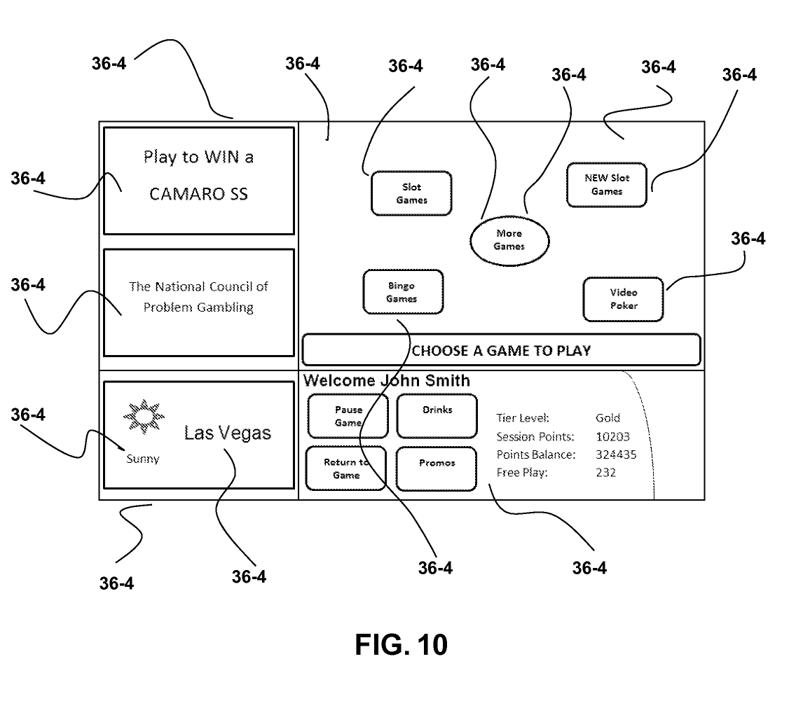

FIG. 10 shows one possible embodiment of FIG. 7 as it may appear to the user after activating additional media selection 54 in order to view the additional media 52 options available. In one embodiment, as illustrated by FIG. 10, the user is provided a general selection of available games and options. By selecting on the general selection, for purpose of example only the general selection “slot games”, the user is then provided a complete list of slot games and options contained in the general selection (not shown). Once the user selects a particular additional media 52, it will then be provided by controller 24, through software or devices as described herein, and occupy first portion 32 of display 30.

In one embodiment, as shown in FIG. 10, reformatted media 26 may be present in the background of display 30 with additional media 52 superimposed over same. In other embodiments, reformatted media 26 may not be visible when the user views additional media 52. This allows the player to concentrate on the additional media 52 as well as entices him/her to interact with additional media 52 since first portion 32 is now dormant except for displaying additional media 52.

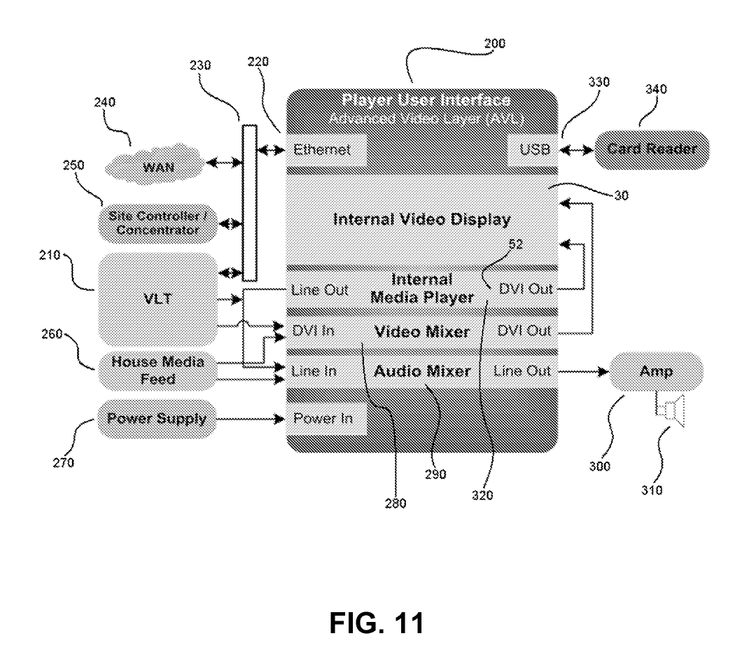

FIG. 11 illustrates one possible embodiment of media player 200. Media player 200 receives inputs from a device such as a media theatre or video lottery terminal 210. The inputs may include, but are not limited to video and audio inputs. Media player 200 may communicate with the venue network via wired or wireless means. In one example, media player 200 employs an Ethernet connection 220 for wired communication with a venue local area network (LAN) 230. However, in other embodiments, wireless means such as communication via radio waves or other similar communications formats are also included. LAN 230 may be in communication with a wide area network (WAN) 240 such as the Internet. WAN 240 may be public or private depending on the connections required by media player 200 and/or the venue. It is envisioned in a further embodiment that a network of media players 200 may be set up to communicate locally through LAN 230 or remotely through WAN 240 to enhance game play as well as to expand the media presentations available to the users and to provide possible tournament play opportunities. LAN 230 and WAN 240 may communicate with one other through devices known in the art such as routers (not shown) and contain switching devices (not shown) as known to those skilled in the art to direct communications to and from the media player through the LAN 230 and/or WAN 240 with a variety of sources, including but not limited to, a venue server, host server, or third party server.

In one embodiment, media player 200 may also communicate with a site controller or concentrator 250 through the LAN 230. The site controller 250 may monitor all equipment at the venue, with the specifics determined by the venue or third parties. The site controller 250 may have alert management capabilities as well as follow up, planning and preventive maintenance, comparison between performances of sites, and an advance report generator in order to ensure smooth operation and communication between the venue components as well as between media player 200 and the venue servers, hosts, and other media players 200 locally or remotely situated.

Media player 200, in another embodiment, is also capable of directly receiving media feeds from the venue, either locally or remotely generated, such as a house media feed 260. House media feed 260 may contain information or media in conjunction with the media delivered from video lottery terminal 210 such as bonus information, win notices, special inducements tied to game play, venue incentives, etc. House media feed 260 can contain feeds such as, but not limited to, audio and video feeds which media player 200 may receive. In one embodiment, media player 200 receives the feeds through a digital visual interface (DVI), a video interface standard known to those skilled in the art that covers transmission of video between a source device such as that providing house media feed 260 and media player 200 or display 30. Transmission may be based on PANELLINK serial format, available from Silicon Image, Inc., 1060 East Arques Ave., Sunnyvale, Calif. 94085. High Definition Multimedia Interface (HDMI) is also a possibility for communicating house media fee 260. Media player 200 should not be read as limited to one system and may use systems known to those skilled in the art now established or later-existing.

Media player 200 may also include a video mixer 280 (also known as a vision mixer, video switcher, or production switcher). Video mixer 280 selects between several different video sources and in some cases composites (mixes) video sources together and may add special effects. This is similar to what a mixing console does for audio. Video mixer 280 may perform hard cuts (switching directly between two input signals), generate a variety of transitions, from simple dissolves to pattern wipes and can perform keying operations and generate color signals (called mattes). Video mixers combine various video signals, thus, the sources may be synchronized. A sync generator (not shown) can be used to accomplish this. Sync can also be achieved by sending out a black burst signal, a reference signal resembling an all-black television signal, from the switcher. Signals which cannot be synchronized (either because they originate outside the facility or because the particular equipment does not accept external sync) may pass through a frame store synchronizer. Some vision mixers have internal “frame-syncs” or they can be a separate piece of equipment, such as a “time base corrector”. If the mixer is used for video editing, the editing console (which usually controls the vision mixer remotely) must also be synced.

Video mixer 280 can be used to resize, reformat, add material to, alter, change, fine tune or otherwise modify the video feed received from both video lottery terminal 210 as well as house media feed 260 and any other video feeds entering media player 200 in order to produce reformatted media 26.

In one embodiment, video mixer 280 can be used to intercept house media feed 260 and the video feed from video lottery terminal 210 and simply act as a through-conduit for same where no reformatting occurs. In one preferred embodiment, reformatting may include modifying the visual feeds to reduce them in size so that they only occupy a percentage of display 30, as described in more detail above, such as 75% of the original display size. Reformatted media 26 can then be transmitted to display 30. The video mixer also allows for insertion of user interface 28 into the video feeds for transmission to display 30 as well as enables providing video feeds associated with additional media 52 when the user activates additional media delivery system 54, as described above.

In another embodiment, media player 200 may also contain an audio mixer 290 (also known as a mixing console, sound board or mixer). Audio mixer 290 can be a digital audio mixer or other mixer known to those skilled in the art. Audio mixer 290 can be used for combining (also called “mixing”), routing, and changing the level, timbre and/or dynamics of audio signals. A mixer can mix analog or digital signals, depending on the type of mixer. The modified signals (voltages or digital samples) are summed to produce the combined output signals. Audio mixer 290 may also add external effects, convert monaural signals to stereo, create an audible tone via an oscillator, add internal effects, etc.

Media player 200 can use audio mixer 290 to intercept and modify audio feeds contained in house media feed 260 and video lottery terminal 210 as well as any other audio feeds directed to media player 200. Audio mixer 290 can also be used for providing audio associated with additional media 52 when the user activates additional media delivery system 54, as described above. Audio mixer 290 can be used to allow the user to hear audio feeds from house media feed 260, video lottery terminal 210, or other input sources, in addition to the audio associated with media provided with user interface 28 so that the player simultaneously hears the separate feeds without them interfering with one another, hampering game play, or interfering with the user experiencing the separate media simultaneously. Audio mixer 290 may then transmit the reformatted audio mixes to amplifier 300 which transmits the audio mixes to speaker 310.

In one embodiment, media player 200 may transmit a user interface along with the reformatted video and audio feeds. This may be a user interface such as user interface 28 described above. As FIG. 12 illustrates, media player 200 may contain hardware 400, or physical components, for providing user interface 28 to display as well as software components 410, or logical components.

User interface 28 could allow for input 440 whereby the user manipulates second media 36 within defined parameters, such as placing a monetary wager using funds or credits, selecting a media feed to experience such as, for purposes of example only, surfing the internet, changing the volume of a sports broadcast, checking the weather outside the casino, texting a friend or someone in the gaming facility, etc. User interface 28 could also be configured to provide output 450 allowing the media player 200 to indicate the effects of the user's manipulation of the second media 36.

In one embodiment, user interface 28 may be a graphical user interface. This type of interface allows the user to interact with the display 30 and media player 200 via images as input 440 rather than text commands. A graphical user interface represents the information and actions available to a user through graphical icons and visual indicators such as secondary notation, as opposed to text-based interfaces, typed command labels or text navigation. The actions are usually performed through direct manipulation of the graphical elements via a touch screen or other receptive medium to receive input 440.

Media player 200 may also contain a controller 430 that allows for a flexible structure in which the interface is independent from and indirectly linked to application functionality. This controller would contain the software 410 used to establish the user interface 28 on display 30 as well as the software 415 allowing for input 440 from the user as well as output 450 to the user, as known to those skilled in the art.

Possible interface architectures include but are not limited to the AIGLX or XGL architectures that allow for usage of OpenGL to animate the user's interactions. Examples of suitable interfaces include, but are not limited to PERCEPTIVE PIXEL, available from Perceptive Pixel, Inc., 102 Madison Avenue, 12th Floor New York, N.Y. 10016, MICROSOFT SURFACE, available from Microsoft Corporation, One Microsoft Way, Redmond, Wash. 98052-6399, 3D IMMERSIVE TOUCH, available from ImmersiveTouch-Sensimeter, info@immersivetouch.com, Xbox KINECT, available from Microsoft Corporation.

Controller 430, in one embodiment a model-view-controller, could also allow for user customization of the user interface 28 such that the user may select a different “skin” for the user interface 28 that appears when the player enters identification information or is otherwise recognized by the system. This may be coupled to allowing the user to manipulate the positions and content of second media 36 as described above. In other embodiments, a registered user can configure second media 36 such that, for purposes of example only, the media may be change the location of second media 36 on the screen and/or the size, color preference, font, brightness, etc., with respect to second media 36. Such configurations can then be saved and stored and associated with the user's login information by controller 430. When the user subsequently logs back on and/or activates his/her account, the display configuration of second media 36 will revert to the configuration previously configured by the user.

However, in another embodiment, user interface 28 may also incorporate “surfaceless” interfaces such as the ZEROTOUCH frame, developed by Texas A&M's Interface Ecology Lab, wherein infrared sensors and LEDs provide a clear visualization of objects within an empty frame, essentially allowing the space within the frame, as opposed to a glass or tempered surface used with touch screens, to surface as the interface medium. Input 440 may also be provided by using a trackball, mouse, or other physical input device, depending on the video lottery terminal 210 where the user interface 28 is presented.

User interface 28 should not be understood to exclude interaction between the user and user interface 28 based on text as user interface 28 may allow for not only graphical input but textual, vocal, such as, for purposes of example only, DRAGON NATURALLY SPEAKING, available from Nuance Communications, Worldwide Headquarters, 1 Wayside Road, Burlington, Mass. 01803, audio and touch sensory interaction. User interface 28 may also be a PARC user interface (PUI) comprising graphical elements such as windows, menus, radio buttons, check boxes and icons. All of which could help to meet the needs of players with physical challenges that might otherwise prevent them from interacting with user interface 28 or simply provide a means of interaction with which a patron is most comfortable.

Indeed, in another embodiment, no direct physical interaction between the user and interface 28 may be necessary as, in a further embodiment, user interface 28 may employ technologies similar to the Nintendo WI or Xbox KINECT wherein the user's movements provide input 440.

Security of user interface 28 may be provided through encryption, passcodes or other methods as known to those skilled in the art. A variety of encryption based security options are possible including but not limited to encrypted disk images, keychain, certificate-based digital signatures, SSL/TLS secure network communication, and Kerberos authentication. Other security options include a personal identification number (PIN) to prevent unauthorized use as well as digital signatures.

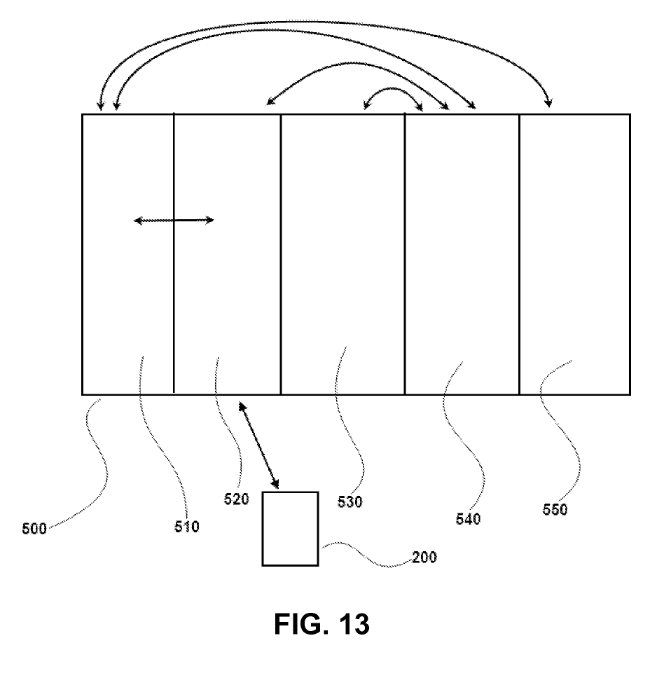

Referring again to FIG. 11, Media player 200 may also contain internal media player 320. Internal media player 320 may be used to store and/or provide additional media 52 when the user activates additional media delivery system 54, as described above. Internal media player 320 may provide video input to video mixer 280 for transmission to display 30 as well as audio input to audio mixer 290. Internal media player 320 may store the additional media 52 internally in a database (not shown), hard drive 500 as shown in FIG. 13, or similar structure or may receive additional media 52 by transmission through the LAN 230, WAN 240, or both. Both video mixer 280 and audio mixer 290 may be used to reformat the audio and visual signals from internal media player 320 in the same manner as signals provided by house media feed 260, video lottery terminal 210, as well as any other video, audio or other feeds directed to or intercepted by media player 200. In another embodiment, video mixer 280 and audio mixer 290 do not reformat the signals from internal media player 320.

Media player 200 may also possess other communication means for communication between media player 200 and devices such as computers, printers, external hard drives, flash drives, card readers, cashing systems, or other peripherals associated with gaming terminals or other audio/video generating devices. In one embodiment, media player 200 may have a USB connection 330 for communication with peripheral devices such as a card reader 340. In this way, media player 200 may be used in association with player awards programs or other programs which track player identities. In one embodiment, only players of a certain level or with certain membership or playing traits may be allowed access to the media provided by media player 200. For example, players with a certain membership or patron level may be provided access to the additional media 52. In other embodiments, certain players may be given full access to the additional media 52 while other players may only be given access to portions of additional media 52 via the player scanning a membership card, or providing other identifying information, through the user interface 28 or via peripheral devices such as a card reader 340.

In a further embodiment, media player 200 may comprise a CPU motherboard with a hard disk 500 partitioned into particular regions, illustrated schematically by FIG. 13. A first region 510 may contain the application software for reformatting the video, audio or other feeds. Another region 520 could contain the game operating system and application software for the game operating system that will communicate with the media player 200 and game content partition. The game operating system may use industry standard communication protocols such as, in one embodiment, GSA SAS protocol approved by the Gaming Standards Association. In one embodiment, GSA SAS protocol 6.0, or later versions, may be used. These protocols allow for secure communication between gaming machines, or other media devices, and peripheral systems, for instance, accounting systems, monitoring systems, or data storage modules.

Hard disk 500 may also have a third region 530 that contains the game contents of a multitude of games, such as card games, ball games such as Keno or bingo, video slot games or other games as described herein or known to those skilled in the art. A fourth region 540 could be a download partition whereby download packages, received from the venue or via the LAN 230 or WAN 240 would reside until provided to the other regions 520, 520 and 530. A fifth region 550 can be used to store background downloaded updates that would be used by region 510. While hard disk 500 is described as having five partitions, it is understood that this number is not determinative and a higher or lower number of partitions are available and hereby disclosed.

Media player 200 may be connected to any conventional power supply. In one embodiment, media player 200 can be separately connected to a power supply. In another embodiment, media player 200 may be connected to power through the power supply used for the video lottery terminal 210 or other device with which the media player 200 is used. This allows for fully integrating the media player 200 into the host device, or for maintaining the device separately from the host device to provide for redundancy as well as to maintain compartmentalization of the devices, as desired. Further, in other embodiments, media player 200 may be incorporated internally into an existing game terminal 22. Media player 200 would be connected to gaming terminal 22 systems with access to all gaming terminal 22 functions. In another embodiment, media player 200 may be a stand alone device that is connected to game terminal 22 but still provided access to the functions of gaming terminal 22.

Other potential uses for media player 200 include in-room gaming at hotels or resorts, instant ticket vending technology, as well as for presenting advertisements and streaming video to existing video architectures.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for providing media on a gaming terminal comprising:
capturing, via a controller, at least one media feed originating from a gaming terminal;
reformatting, via the controller, the media feed to occupy a first portion of a display;
transmitting, via the controller, the reformatted media feed and a user interface to the display wherein the user interface occupies a second portion of the display; and
providing a second media, via the user interface, that is unassociated with the content of the media feed.

2. The method of claim 1, wherein the media feed originating from the gaming terminal comprises a video feed.

3. The method of claim 1, wherein the media feed originating from the game terminal comprises at least one video feed and at least one audio feed.

4. The method of claim 1, wherein reformatting the media feed to occupy a first portion of the display is achieved by reducing the size of a video portion of the media feed on the display.

5. The method of claim 4, wherein the size of the video portion of the media feed is reduced by at least 25%.

6. The method of claim 1, wherein the first portion of the display occupies a larger area of the display than the second portion of the display.

7. The method of claim 1, further comprising wherein the second media may exchange positions on the display with the reformatted media feed.

8. The method of claim 1, further comprising wherein the second media may occupy the entirety of the display.

9. The method of claim 1, wherein reformatting is accomplished by using a software streaming algorithm to reformat the media feed.

10. The method of claim 1, wherein the user interface provides at least two forms of media in the second portion of the display.

11. The method of claim 10, wherein the second media may be selected from streaming video, live sports feeds, pay-per-view selections, internet websites, news feeds, weather forecasts, gaming establishment advertisements, wagering events, game play, or real-time video.

12. The method of claim 1, wherein the second media comprises interactive media such that the user may influence the second media.

13. The method of claim 12, wherein the interactive media comprises at least wagering, gaming, social, or communications media.

14. The method of claim 1, wherein the user interface provides gaming activities that are unassociated with the gaming activities supplied via the gaming terminal.

15. The method of claim 14, wherein the user interface provides similar gaming activities as the gaming terminal but game play and results of the games are not intertwined or dependent upon one another.

16. The method of claim 1, wherein the user interface allows the user to supplant the media feed with additional media provided by the controller.

17. An apparatus for providing media on a display comprising:
a media player for intercepting at least one feed originating from a device;
wherein the media player reformats the at least one feed to occupy a first area of a display wherein the area occupied is less than the area the at least one feed would have occupied before reformatting;
and wherein the media player transmits the reformatted at least one feed and a user interface to the display, the user interface occupying a second area of the display; and
the user interface configured to provide media unassociated with the at least one feed originating from the device.
